(19) United States
(12) Patent Application Publication
(10) Pub. No.: US 2026/0151859 A1
(43) Pub. Date: Jun. 4, 2026

(54) Laser Engraving And Cutting Machine

(71) Applicant: Tong Li, Haslett, MI (US)

(72) Inventor: Tong Li, Haslett, MI (US)

(21) Appl. No.: 19/318,062

(22) Filed: Sep. 3, 2025

Related U.S. Application Data
(60) Provisional application No. 63/726,570, filed on Dec. 1, 2024.

(51) Int. Cl. B23K 26/364; B23K 26/06; B23K 26/082; B23K 26/402; B23K 26/70; B23K 103/00

(52) U.S. Cl. CPC B23K 26/364; B23K 26/0648; B23K 26/082; B23K 26/402; B23K 26/703; B23K 2103/36; B23K 2103/42

(57) ABSTRACT

An engraving system having multiple laser sources mounted on an upper plane within a housing for directing respective output beams to a lens unit located for movement along a lower X-Y plane within said housing to a Z-axis lens unit that redirects the selected laser beam to a target. The laser sources may be selected to produce beams of different character such as wavelength to engrave different materials. The beam paths may be entirely separate or partially shared. If separate, the selection of an operative laser is carried out using a system for rotating the Z-axis lens unit into a position presenting the correct mirror to the incoming beam. If partially shared paths are used, one laser may be moved into and out of the shared path position.

### CROSS-REFERENCE TO RELATED APPLICATION

This application claims priority to and the benefit of U.S. Provisional Application Patent Ser. No. 63/726,570, filed Dec. 1, 2024, the entire disclosure of which is hereby incorporated by reference.

### BACKGROUND OF THE INVENTION

This subject matter disclosed herein is in the field of laser engravers and, more particularly, in the field of laser engravers having multiple laser sources. As hereinafter disclosed, the laser sources may be different in various ways; for example, they may differ in power level or in the output beam wavelength, the differences chosen serving to allow the system to selectively engrave articles of differing material content. By way of example and not by way of limitation, one laser may be a CO₂ laser while the other laser may be a fiber laser.

In conventional laser engraving and cutting machines, the laser source and its exit window are positioned at the same level as the beam's x-y motion plane. This arrangement facilitates x-y axis movement of the focused laser head. However, it takes away space for lens movement in the X-Y plane within the housing, thus reducing the available engraving area.

The engraver disclosed herein overcomes this limitation by mounting the laser sources in a plane above the x-y motion plane for the lens unit. Systems of reflecting mirrors are introduced to redirect the laser beams down to the x-y engraving lens plane. By relocating the laser sources as described, usable engraving space within the machine's footprint is maximized.

As stated, the disclosed engraver provides a mounting system in which the laser sources are mounted in an X-Y axis plane above the X-Y plane of movement of the focusing lens unit that receives the input beams from the laser sources, thus allowing full width of travel of the lens unit within the laser housing, unimpeded by Y-axis support structure for the X-axis track device that carries the lens unit.

As herein disclosed, the multiple laser concept can be structured in an arrangement wherein both of two lasers direct their beams along a partially-shared beam path in the X-Y plane to the lens unit or, alternatively, along separate and partially opposite paths to the lens unit.

### SUMMARY OF THE DISCLOSURE

As described above, in the multiple embodiments herein described, the laser sources are advantageously mounted on a plate in an upper plane of a housing that provides an X-Y-Z orthogonal axis system whereas the lens unit for all lasers is mounted in an X-Y plane below the X-Y plane on which the laser sources are mounted thereby allowing maximum travel of the lens unit.

The housing can be equipped with levelers to sit on an open-frame carriage designed to accommodate a target article below and in the range of the focusing unit. If needed, a cart capable of holding target articles can be positioned within the side panels of the carriage.

The lasers have beam paths established by strategically located mirrors that may be wholly separate or partially shared as hereinafter illustrated and described. Where the two-plane arrangement is used, all beam paths start out in the upper X-Y plane but ultimately reach the plane in which the lens unit moves. The lens unit can have multiple wavelength-specific mirrors joined in a structure mounted for rotation or other selectable movement to selectively bring the correct mirror into position over a focus lens to focus the chosen input beam to a target surface. If the lens unit can accommodate different input beam content, no such movement is needed.

Embodiments are also disclosed which mount multiple laser sources in a housing that includes a mirror-based beam path system in which a mirror associated with at least one laser can be selectively moved into and out of a position where it blocks the beam from another non-selected laser and joins a shared beam path to the Z axis lens unit. In this arrangement the final beam path portion reaching the focusing unit is shared by all of the laser sources. In another embodiment, the beam paths are totally separate and reach the lens unit from opposite directions.

A control system is provided to allow an operator to selectively power up the multiple lasers and activate components such as linear actuators with high precision limit switches to place the mirrors in position to accurately accomplish the desired engraving result.

It is to be understood that the term “engraving” as used herein is to be construed to include etching, cutting and otherwise marking a target surface to produce a desired result such as the formation of letters, numbers and images

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of a laser engraver comprising an upper housing resting on a lower carriage;

FIG. 2 is a perspective view of a rectangular laser-mounting plate located within the housing and in an X-Y coordinate plane with two lasers of different type mounted thereon and showing the beam path of one of the two lasers to cause the beam to reach a Z axis focusing unit;

FIG. 3 is another perspective view of the mounting plate showing the beam oath of the second laser to the lens unit;

FIG. 4 is another perspective view showing the laser support plate above and parallel to the target mounting structure;

FIG. 5 is a detailed view of the laser support system indicating how the rotatable lens unit is movable in and along the X and Y coordinates for tracking a desired target layout;

FIG. 6 is a diagram of an exemplary control system for a two laser embodiment;

FIG. 7 is a two-part diagram of a two laser system where the lasers share part of the beam path system and are selected for operation by movement of a laser source;

FIG. 8 is a diagram of a lens unit with a rotatable beam-directing mirror component driven by a step motor, which is controlled by a program, mounted on the X axis and directing the selected beam downwardly to aa adjustable lens for focusing the selected beam on a target;

FIG. 9 is a two-part diagram of the laser system of FIG. 7 wherein the laser sources are arranged perpendicular to one another;

FIG. 10 is a diagram of a switch system for controlling the elements of the laser systems disclosed herein;

FIGS. 11-13 are partial views of an alternative laser mount with a mirror system that allows each laser to redirect its beam path downwardly to a lower plane as shown and described with respect to FIG. 8.

### DETAILED DESCRIPTION

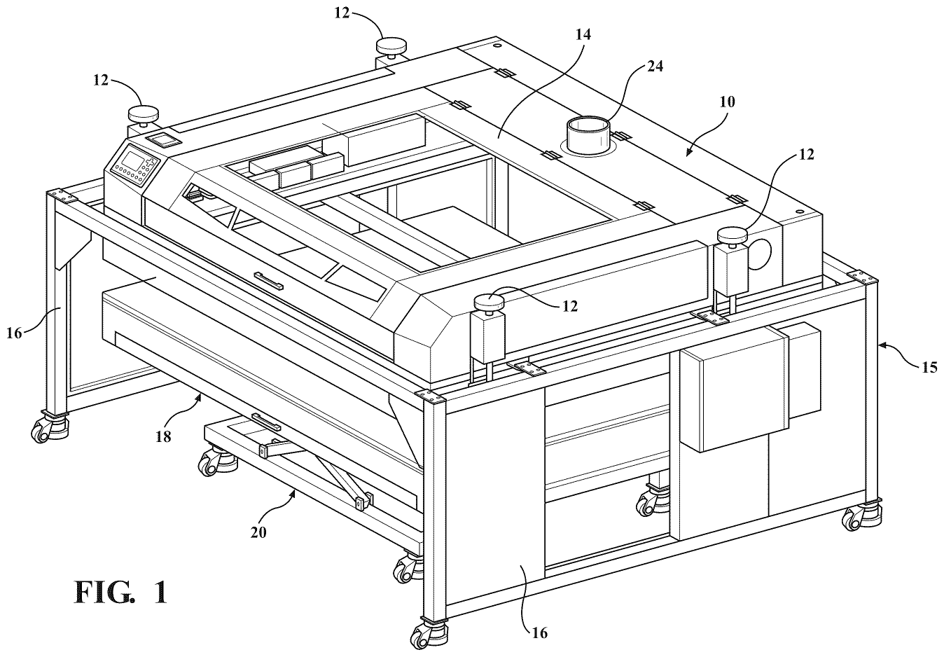

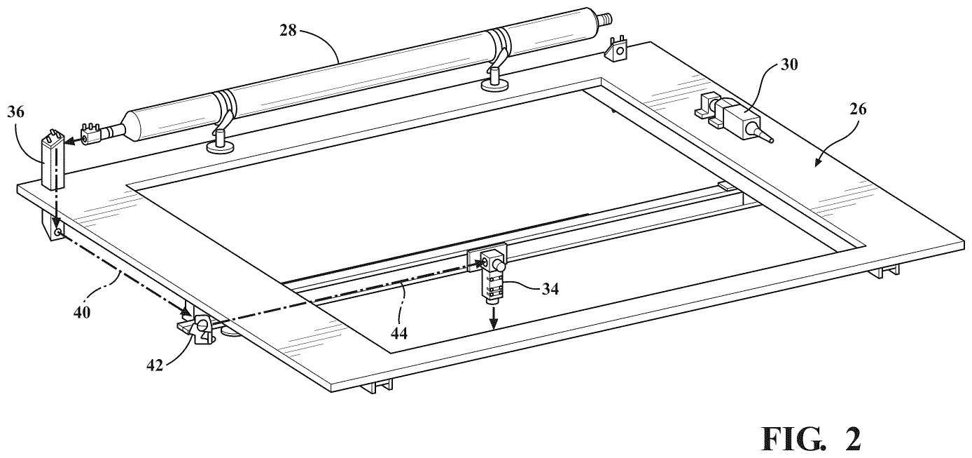

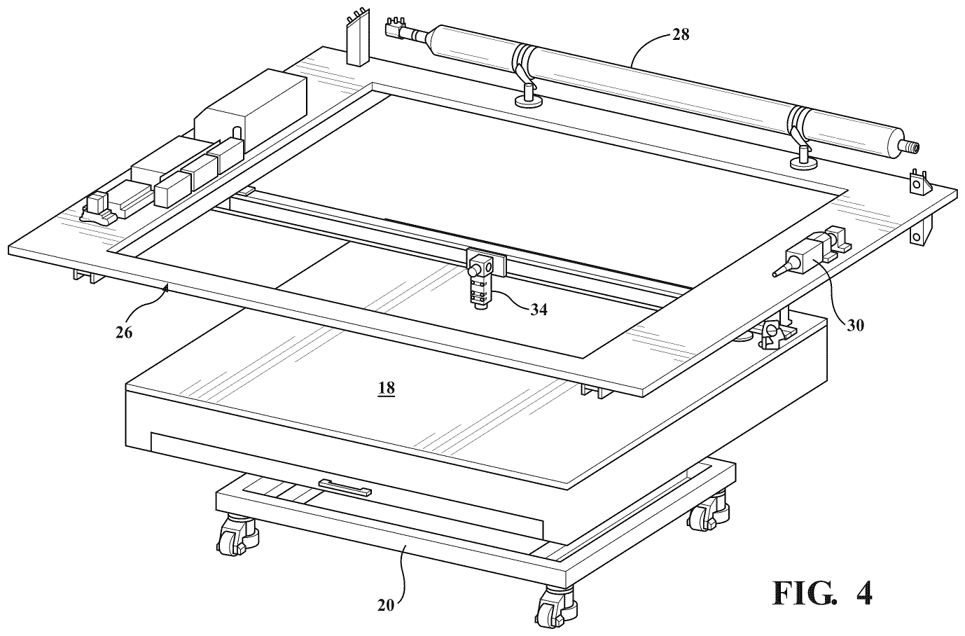

The FIGS. illustrate exemplary laser engraving systems for accommodating articles to be engraved. FIG. 1 shows a the laser engraving system to comprise as major components a generally rectangular housing 10, a lower carriage 15 on which the housing 10 rests, and an optional cart 20 that carries a table 18 that can hold articles to be engraved within the carriage and in the range of a Z-axis lens unit for the lasers mounted in the housing as hereinafter described with reference to FIGS. 2 through 5.

In the first embodiment to be described the housing 10 provides support for at least two lasers of different types emitting beams of different wavelengths for working on articles of different materials. The housing 10 has a hinged top lid 14 with a protective see-through glass center panel for an operator to look into the interior of the housing and preventing laser beams from escaping the case. An exhaust port 24 is provided. Screw shafts 12 are mounted near the four corners and extend downward to the top surface of the lower carriage 15 allowing for adjustment such that the laser focus plane is parallel to the surface being engraved. The screw shafts 12 may be individually adjusted to change the height and angle of the housing 10 relative to the lower carriage 15.

The side panels 16 of the carriage 15 are essentially vertical and are spaced apart to allow a cart 20 to be inserted into the space between the side panels 16 and below the housing which, as hereinafter described, includes laser beam directing mirrors bringing the laser beams to a downwardly aimed focusing lens to direct laser outputs, one at a time, to articles placed on the top surface of a cutting table 18 supported by the cart 20. The cart is mounted on casters and has a motor driven adjustable top support surface for a honeycomb cutting table 18 so that it may be raised and lowered to bring articles placed on the top surface of the cutting table 18 into focus. The general arrangement of a laser housing mounted on a carriage that can accommodate the cart for holding articles of various types and sizes is disclosed in my previously-issued U.S. Pat. No. 11,446,761 the entire disclosure of which is incorporated herein by reference.

There are multiple ways to provide for use of two lasers mounted for outputs parallel to one another in the X-Y plane: one is to use mirrors to provide fully separate beam paths while the other is to use mirrors to provide a partially shared beam paths.

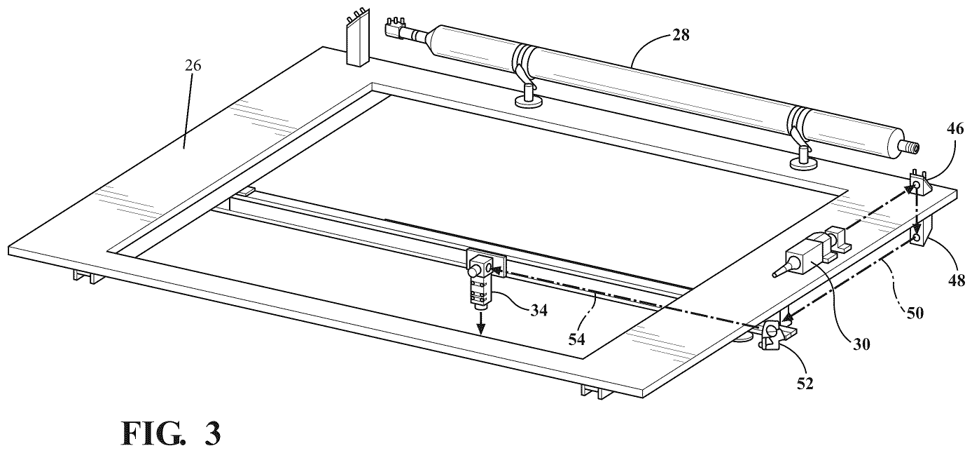

Referring now to FIGS. 2-5, there is shown within the housing 10 a rigid rectangular plate 26 which is mounted in an upper X-Y axis plane to support lasers 28 and 30 of which 28 is a CO2 laser in this case, and 30 is a fiber laser. The large CO2 laser 28 is mounted on the plate 26 to produce an output beam in a generally horizontal first path segment along the X axis of an XYZ orthogonal axis coordinate system, whereas the fiber laser head 30 is oriented on the plate 26 to produce an output beam along and parallel to the Y axis of the coordinate system. FIG. 2 shows the complete beam path for CO2 laser 28 whereas FIG. 3 shows the complete path for the beam from fiber laser 30. Each path has a mirror system to create a Z-axis component to bring the beam down to the X-Y axis plane below and parallel to the plane of plate 26 in which the lens unit 34 moves. By virtue of mirror systems, the final legs of both beams reach the lens unit 34 from opposite directions in a lower X-Y axis plane than the plane on which the laser sources are mounted, thus conserving space within the housing and allowing the unit 34 to move the full width of the housing 10. The lens unit 34 is mounted on an X-axis track member that sits below the track elements 56 and 58 that lie along the Y-axis. The unit 34 is constructed to aim the selected input beam through a pattern chosen by programming to impart a pattern of engraving on the surface of an article on the table 18 as hereinafter described in greater detail.

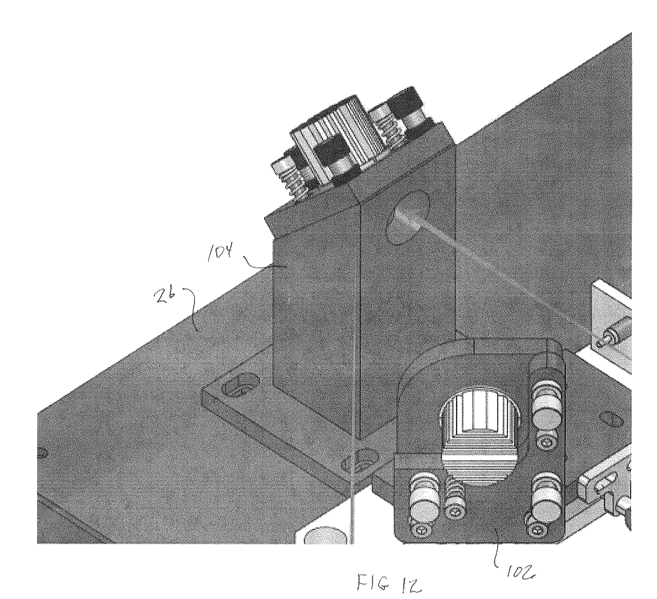

The lasers are turned on one at a time by the control system of FIG. 10. Thus, only one beam reaches the lens unit 34 at any given time. The CO2 laser 28 directs its beam first toward a mirror unit 36 located in a corner of the panel 26 to redirect the laser beam downwardly along the Z axis. The lower elements of the mirror unit 36 redirect the beam from laser 28 into path 40 which brings it along the Y axis to mirror unit 42. That mirror unit redirects the beam from laser 28 along path 44 to Z axis lens unit 34.

Turning now to FIG. 3, the laser beam from fiber laser 30 is directed along a Y axis path to the mirror unit 46 which redirects the beam downwardly along the Z axis to mirror unit 48 which in turn redirects the mirror along path 50 to the mirror unit 52 which is spaced along the Y axis from the mirror unit 48. The mirror unit 52 redirects the beam along X-axis path 54 to the lens unit 34.

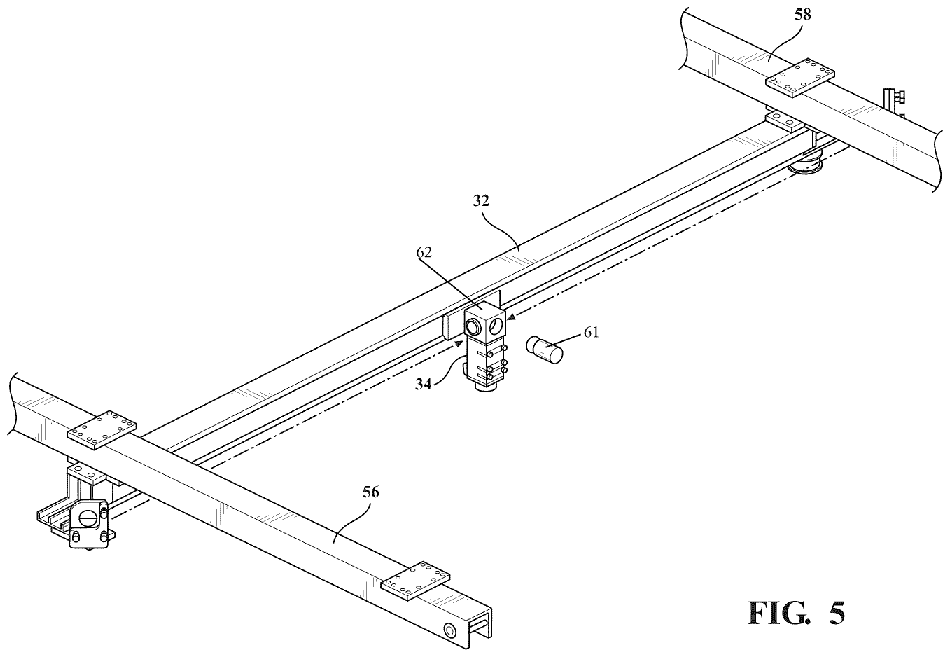

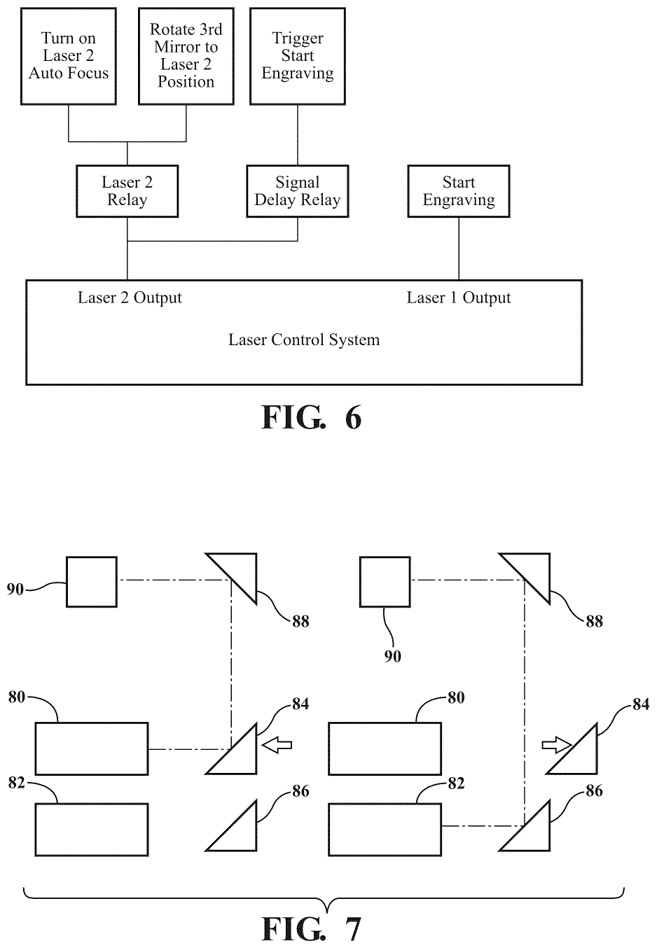

As best shown in FIG. 5 the lens unit 34 is mounted in an X-Y axis track system including an X-axis track member 32 mounted under and movable with respect to Y-axis track members 56 and 58 that are located toward the right and left sides of the housing 10. The control system of FIG. 6 is employed in a known fashion to direct the lens unit 34 in two-dimensional space through a pattern corresponding to the content of the message and/or image to be imparted by engraving to the target article.

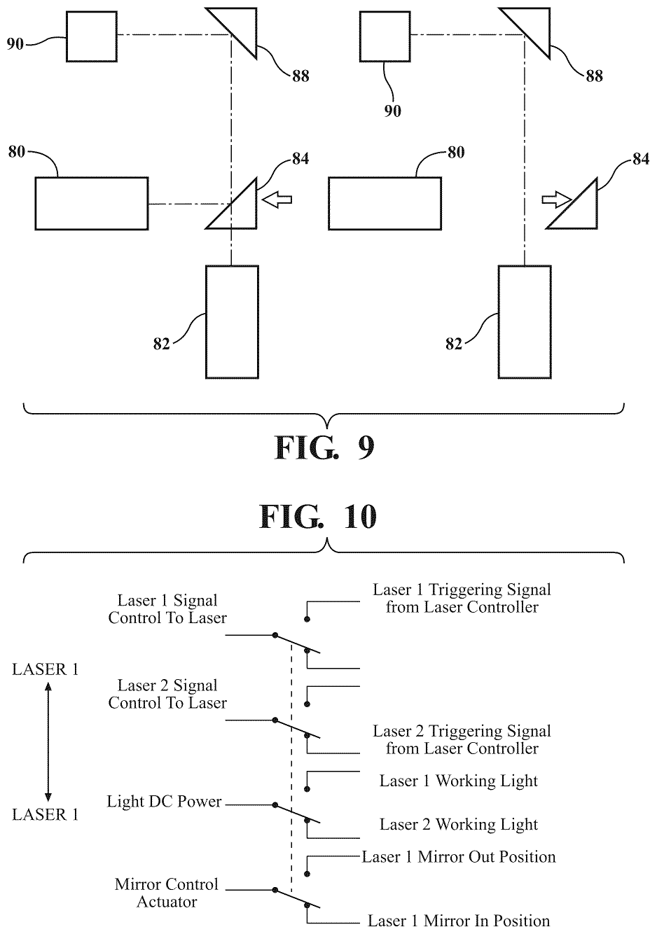

As described above, the laser sources 28 and 30 are selectively activated by operation of the control system shown FIG. 6 to produce outputs one at a time so that only one laser is activated to produce a beam reaching the focusing unit 34 and that unit is rotatable to bring the proper mirror into operation to redirect the activated input laser beam downwardly along the Z axis to perform the engraving operation on the article resting on the cutting table 18. As hereinafter shown in FIG. 8, unit 34 is rotatable to bring each of two mirrors into play, one at a time, thereby to direct the selected laser beam toward the article on the table carried by the cart 20.

Referring again to FIG. 5 the frame like support panel 26 with the two lasers 28 and 30 mounted thereon is located above and generally parallel to the cutting table 18 and the cart 20 so as to direct the laser beam of selected wavelength to the lens unit 34 which is located on an X-axis track member 32 connected at both ends to Y axis power tracks on the frame 26 so that the lens unit 34 may be selectively moved along X and Y axes as needed to produce the desired engraving pattern. The beam 32 is mounted on parallel linear tracks located under the left and right sides of the frame 26 as are well known in the art to move the beam 32 along the Y axis. The two axis, i.e. the X-Y axis movement, is well understood in the art to be capable of carrying out the desired process of forming numbers, letters and/or images of desired character and content.

The track member 32 on which the lens unit 34 is mounted for movement along the X axis is shown connected to the undersides of the track elements 56 and 58 for movement of the beam 32 and the lens unit 34 along the Y axis, the orthogonal axis system being effective to perform engraving operations of desired characters as previously described. The X-Y track system is disclosed in my U.S. Pat. No. 11,446,761 the content of which is hereby incorporated by reference in full.

The lens unit 34 as best shown in FIG. 8 comprises two mirrors 60 and 62 mounted back-to-back with heat transmitting body 64 in between. The mirrors are mounted for rotation about axis 66 by a step motor 61 to direct the selected laser beam downwardly to lens 68 that is adjustably mounted in a frame 70 for focusing on a target surface. The step motor is provided to rotate one of the two redirecting input mirrors into position to receive the beam from the selected laser and redirect that beam downwardly to the lens unit 34.

By way of review, the engraving device thus far described herein includes a housing structure with an upper interior support on which two lasers of different types are mounted so as to direct their respective laser output beams along separate multi-lane paths within an X-Y-Z orthogonal coordinate system. The paths are arranged by strategically located mirror units to bring the final legs of their respective beams into a lens unit from opposite directions along paths in a lower x-axis plane. The lens unit is constructed with two mirrors, and the unit is selectively oriented by rotation around the Z axis to direct only one of the beams at any given time downwardly toward a target to be engraved.

Where the beams are different types emitting different wavelengths, the selected beam is chosen to fit the material of the target so as to most effectively perform the desired engraving operation. The system is not limited to any particular type or types of lasers or to the requirement that the lasers operate to produce beams of different wavelengths. By way of example, one laser may be a CO2 laser within output 10600 nm whereas the second laser may be a fiber laser with an output wavelength of 1064 nm. In this case, the mirrors in the unit 34 are selected for a match to the input wavelengths.

Alternatively, the CO2 may otherwise be of high-power type for cutting acrylic and wood. The second laser may be a low-power RF CO2 laser for fast engraving.

The drawings highlight the dual-laser mirror module inside the beam delivery system. This system uses a two-layer, side-by-side design. Both laser sources are placed above the x-y motion plane, allowing the laser head to move freely across the entire area within the machine's frame. This design significantly increases the engraving area without increasing the machine's overall size.

When the CO2 laser is active, the actuator mirror moves out of the beam path, allowing the CO2 laser beam to reach the double mirror. The double mirror then reflects the beam down to the x-y beam plane, directing it forward into the x-y beam path.

Persons skilled in the engraving art will be familiar with the relationship between different engraving wavelengths to cut different materials such as thin films, and certain plastics as well as materials that are used for by way of example, the construction of circuit boards.

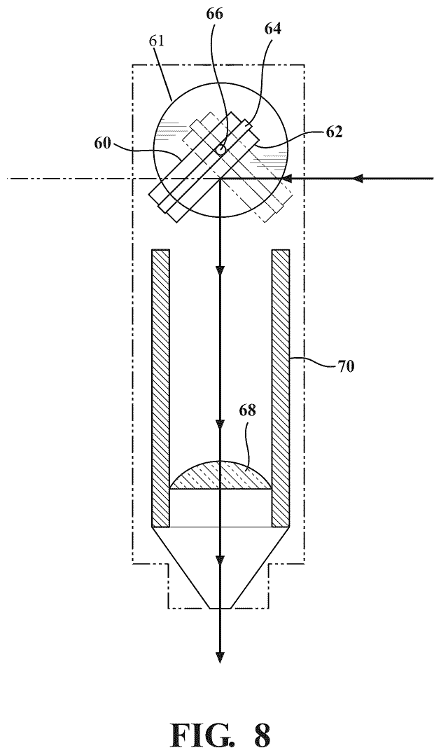

Referring now to FIG. 7, the system shown there comprises lasers 80 and 82 which may be of different types having output beams directed to mirrors 84 and 86 respectively that can be positioned to redirect the beams, one at a time, to mirror 88 that directs a beam to lens unit 90. On the left side of FIG. 7 the laser 80 is selected and mirror 84 is in a blocking position to prevent the beam from laser 82 from reaching the shared mirror 88 along the shared beam path while laser 82 is turned off. Mirror 84 is movable by a linear actuator. On the right side of FIG. 7, laser 82 is selectively turned on and he linear actuator is used to move mirror 84 out of the blocking position to allow the beam from laser 82 to reach the lens unit 90. Where the lasers are of different types to emit beams of different wavelengths, the lens unit is constructed and mounted as described above to provide directional mirrors of correct composition to direct the selected beam to the lens. In this embodiment the beam paths for the lasers are partially separate and partially shared. When used in the two-level mounting arrangement of the above-described embodiment, additional mirrors are used to bring the separate portions of the beam paths down to the level of the focusing unit 90.

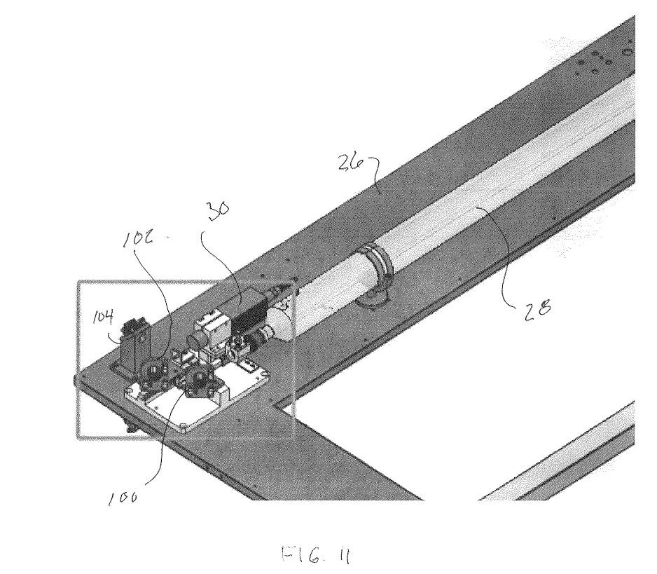

As shown in FIG. 9, the lasers 80 and 82 may alternatively be mounted perpendicular to one another on a panel in the housing 10 rather than parallel as shown in FIG. 7. This saves one mirror unit but employs the same principle of moving components associated with one laser in and out of operative position to selectively use the two lasers.

Referring to FIG. 9 the laser sources 80 and 82 are here arranged perpendicular to one another and again the mirror 84 is movable by a linear actuator out of the path of the beam from laser source 80 when laser source 82 is selected for use. The laser sources in both FIGS. 7 and 9 may be mounted on a plate-like panel within the housing 10 for uses described generally above. The perpendicular arrangement of FIG. 9 has the advantage of eliminating mirror 86.

FIG. 10 is a switch array for the laser systems of FIGS. 7 and 9. The legend “Laser 1” refers to laser source 80 whereas “Laser 2” refers to laser source 82.

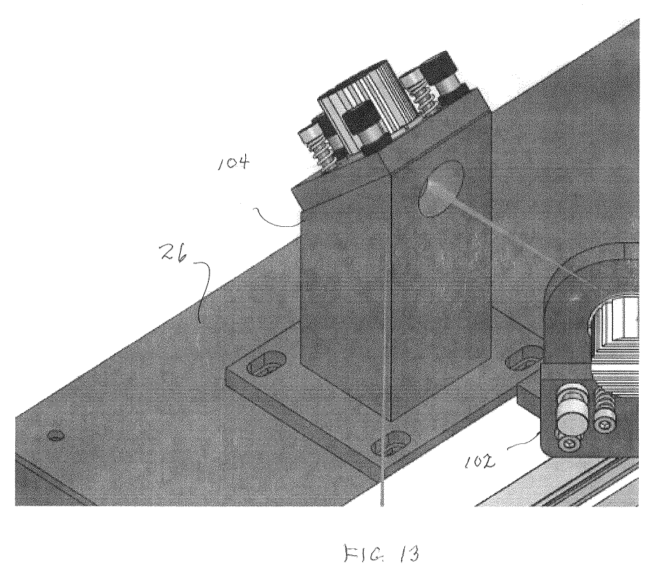

FIGS. 11-13 show a system where lasers 28 and 30 are mounted side-by-side on plate 26 to direct their beams, when turned on, to mirror units 100 and 102 respectively, of which unit 102 is mounted for movement between an inactive position shown in FIGS. 11 and 12 where it directs the mirror unit 100 beam from laser 28 to direct its beam to the mirror unit 104 which redirects the beam downwardly to the plane on which the lens unit 34 resides. AS sown in FIG. 13, the mirror unit 102 is moved into an active position where it redirects the beam from the fiber laser 30 to mirror unit 104.

What is claimed is:

1. A laser engraver comprising;
a housing defining an XYZ orthogonal axis coordinate system;
first and second laser sources mounted within the housing, each source being capable of producing an output beam;
a lens unit for directing an input laser beam to a target surface;
means including mirrors for establishing beam paths within said housing for each of said laser sources to said lens unit, and
means for selectively actuating said laser sources one at a time.

2. The laser engraver defined in claim 1 wherein portions of the beam paths are shared.

3. The laser engraver defined in claim 1 wherein the laser sources produce output beams of different characters, and the means for selectively directing is associated with the lens unit.

4. The laser engraver defined in claim 3 wherein the lens unit has two beam-directing mirrors, one for each wavelength.

5. The laser engraver defined in claim 4 wherein the lens unit includes means for rotating said mirrors between two positions wherein each position redirects a given beam toward a target location.

6. The laser engraver defined in claim 5 wherein the lens unit further includes an element positioned to draw heat from the two beam-directing mirrors.

7. A laser engraver defined in claim 2 further including actuator means for moving one of the laser sources into and out of an active position wherein the output beam from said one source joins the shared path and blocks the other source from using that path to reach the lens unit with its beam.

8. A laser engraver as defined in claim 3 further including a support member mounted in an upper X-Y plane within said housing, said sources being mounted on said support member with outputs aimed in different directions; said lens unit being mounted in an X-Y axis movement plane below the plane on which said sources are mounted;
mirror-based means for directing the output beams from the sources toward the lens unit along final paths in an X-Y axis plane below said upper plane; and
means associated with the lens unit for selectively redirecting the beams from the two sources along the Z axis to a target location.

9. The laser engraver defined in claim 8 wherein the means associated with the lens unit comprises an assembly of two mirrors and a motor for rotating said assembly between two stable positions wherein each position redirects only one of the beams to the target location.

10. The laser engraver defined in claim 9 further including a heat sink operatively associated with lens unit mirrors for dissipating heat therefrom.

11. An engraver apparatus comprising:
a first laser producing a first output beam along a first path;
a second laser producing a second output beam along a second path separate from the first path;
each of said first and second lasers having a mirror system associated therewith for directing beams from said first and second paths to a shared path leading to a focusing lens aimed at a target to be engraved; and
means for moving the second laser and the mirror system associated therewith between an inactive position where the beam therefrom does not reach the shared path and a second active position where the beam therefrom does reach the shared path and blocks the beam from the first laser from joining the shared path.
